(19) United States
(12) Patent Application Publication
(10) Pub. No.: US 2011/0081244 A1
(43) Pub. Date: Apr. 7, 2011

(54) Spiral design

(76) Inventor: Young Ho Ro, Herndon, VA (US)

(21) Appl. No.: 12/923,041

(22) Filed: Aug. 31, 2010

Related U.S. Application Data
(60) Provisional application No. 61/272,527, filed on Oct. 5, 2009.

(51) Int. Cl. F03B 3/12

(52) U.S. Cl. 416/176

(57) ABSTRACT

New design of wind and or water mill, which utilizes natural motion to create electricity. Using a spiral shape design compared to the traditional wind and or water mill designs already in use today. Using a spiral shape design with a tapering angled blade and or size and or a guide, the blades should allow for less drag and increase wind and or water spiral affect efficiency. And the Spiral Design can also be used to replace traditional propellors, efficiently utilizing the motion for thrust.

### Purpose:

New design of wind and or water mill, which utilizes natural motion to create electricity. Using a spiral shape design compared to the traditional wind and or water mill designs already in use today. Using a spiral shape design with a tapering angled blade and or size and or a guide, the blades should allow for less drag and increase wind and or water spiral affect efficiency. And the Spiral Design can also be used to traditional propellors, efficiently utilizing the motion for thrust.

### Construction:

The overview drawing shows the basic design with the blades of the wind and or water mill, starting with a steep angle tapering the blade's angle to the end, until a straight angle is achieved. Within the cone shape center base, a generator is placed within the spiral mill.

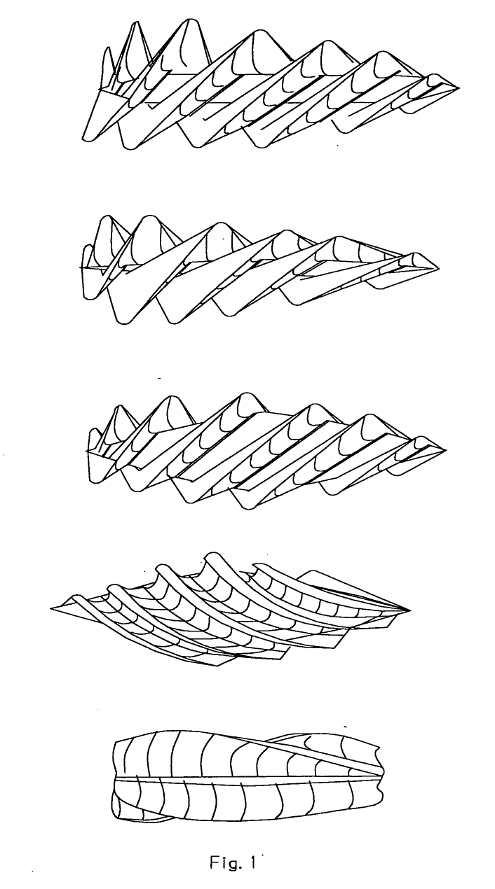

FIG. 1

Shows the four basic designs for the spiral mill and or propellor.

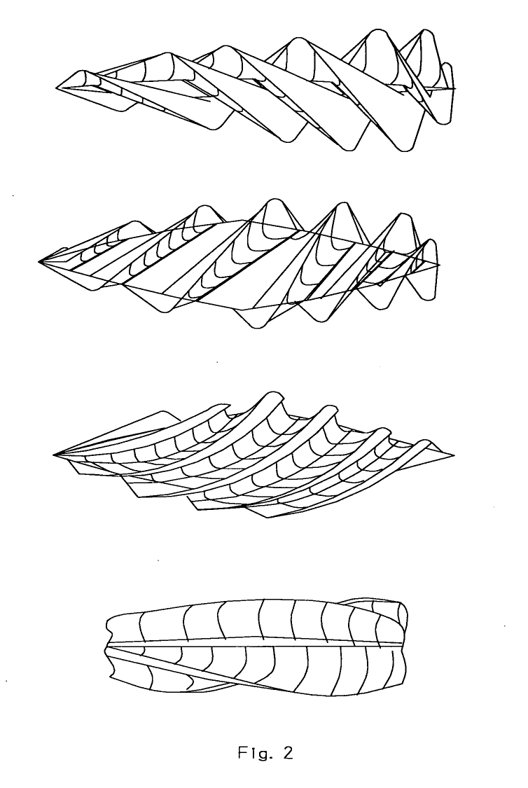

FIG. 2

Shows the four basic design in reverse, which will also provide the'same affects as FIG. 1. Dependent on wind and or water conditions.

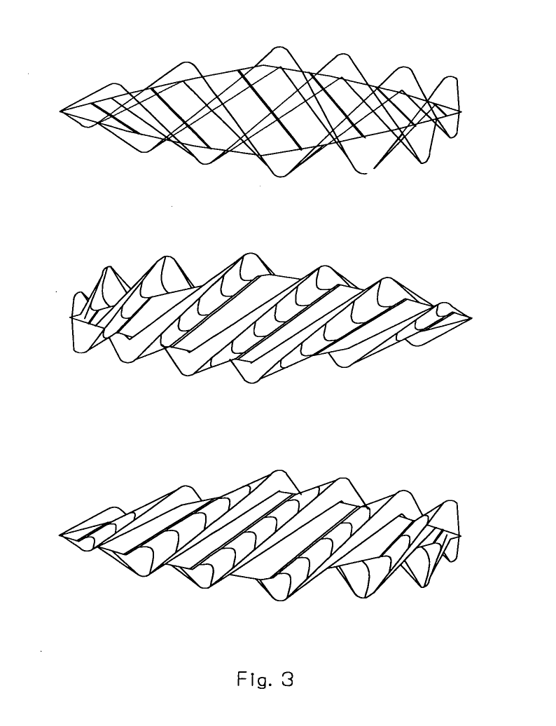

FIG. 3

Shows design 1, which has a tapering angled blades.

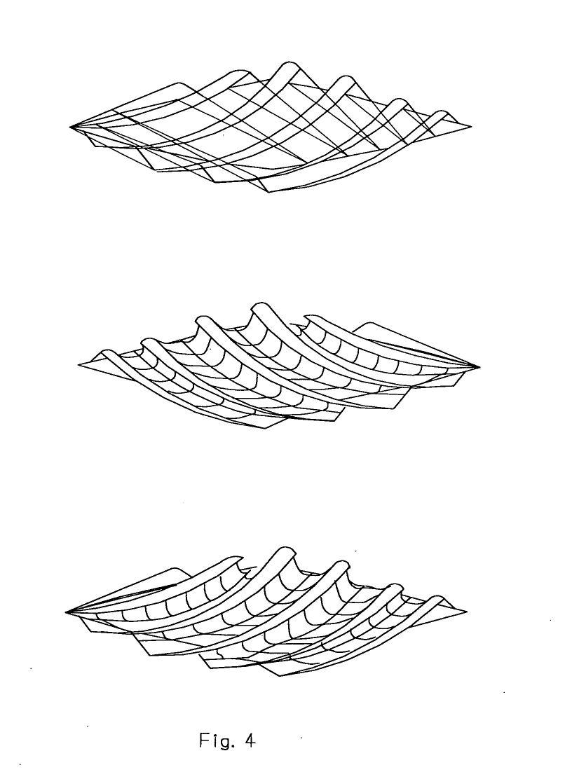

FIG. 4

Shows design 2, which has a tapering angled and tapering blades size.

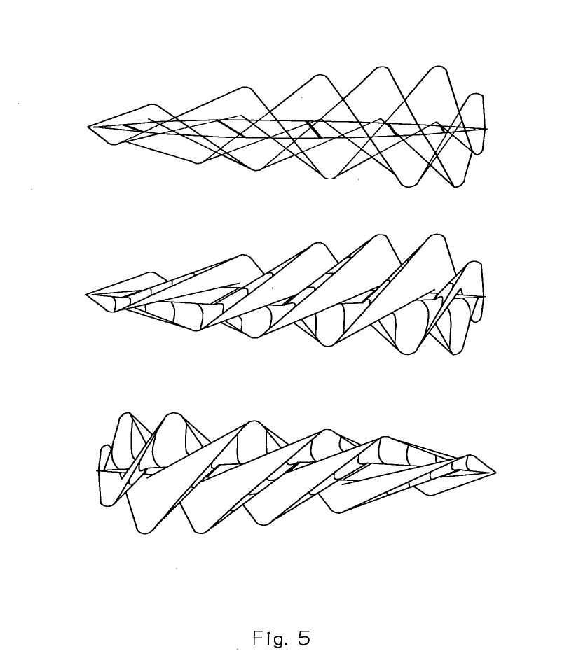

FIG. 5

Shows design 3, for the purpose of using the design for a propellor.

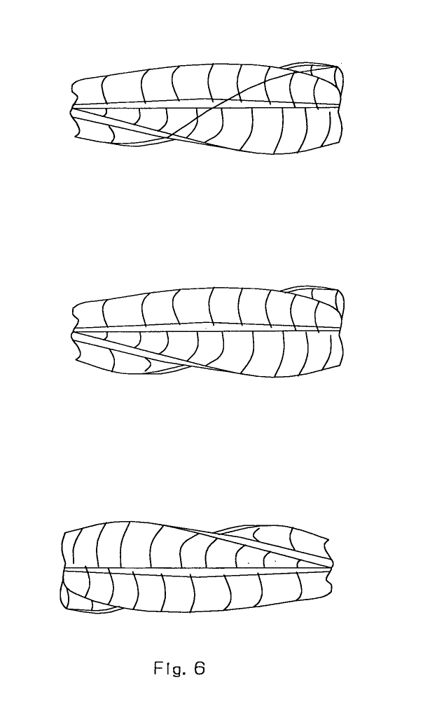

FIG. 6

Shows design 4, for the purpose of using the design for a propellor with a decreased angled change.

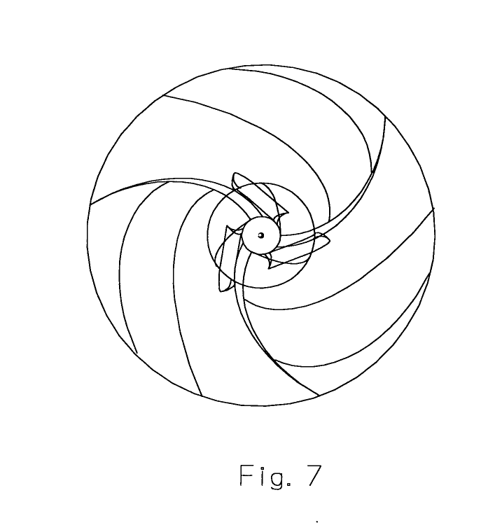

FIG. 7

Shows the front view of all the designs.

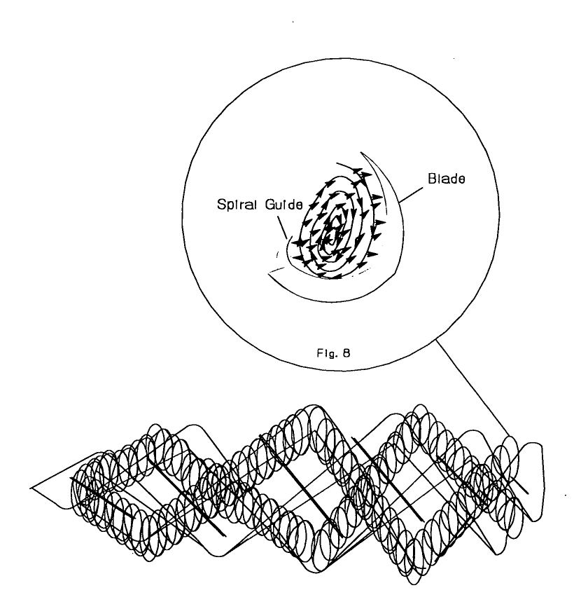

FIG. 8

Shows the motion of the wind and or water using the guide, to completely utilizing the force of the wind and or water momentum efficiently through it's blades. Creating a spiral affect continuously within the blades and around the complete spiral mill and or propellor, as the mill and or propellor continuously rotates and creates the rotation needed for the generator to create electricity. Although the guide will create a small negative push, the spiral affect (positive push) created will out weight the negative push of the guide along the complete blades.

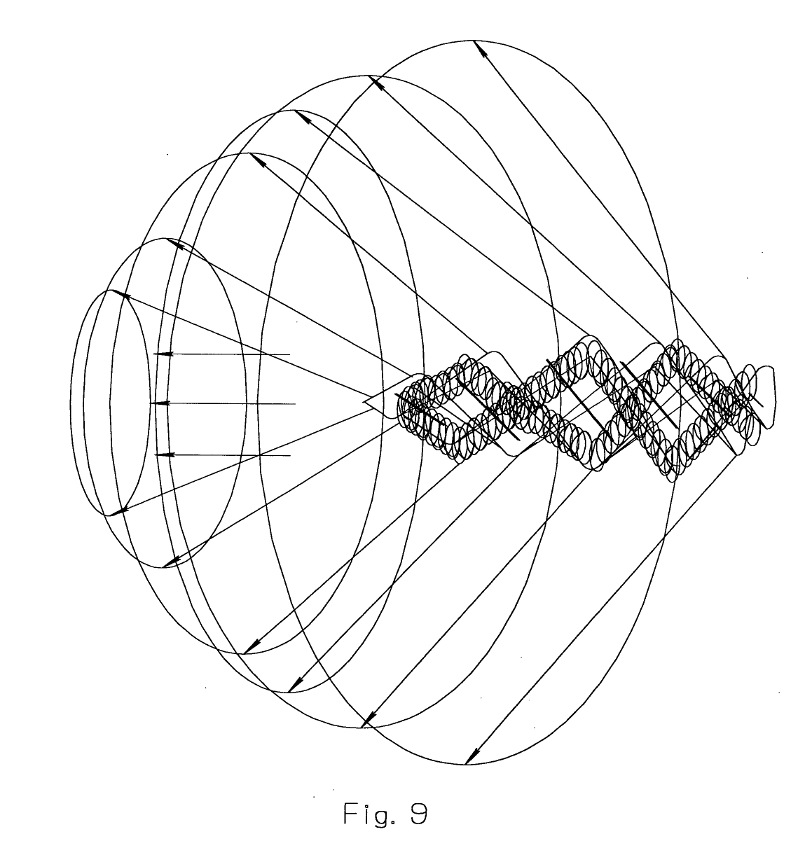

FIG. 9

Shows the thrust and or exiting points of the wind and or water for the design.

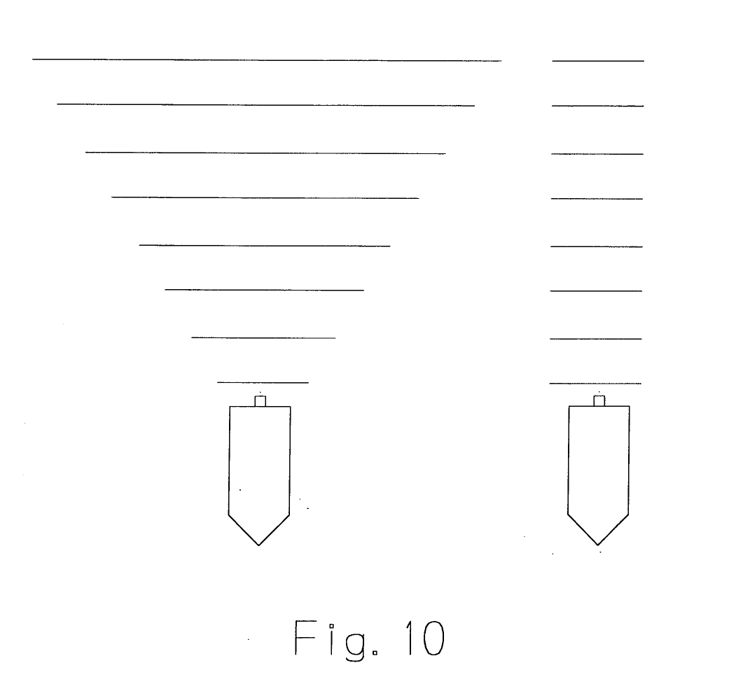

FIG. 10

Shows the comparison between the spiral design and the traditional thrust used as a propellor.

### Function:

As the strength of the wind and or current changes, the spiral mill can withstand any and all natural conditions. Along with the base that will rotate in the direction of the wind and or current, the spiral mill provides higher quality and durability for today's changing environment. Also the spiral design can also be used to replace traditional propellors utilizing the complete shape to generate thrust, and utilizing the all the torque in todays motors. To provide more efficient use of energy.

1. New design of wind and or water mill, which utilizes natural motion to create electricity. Using a spiral shape design with a tapering angled blade and or size and or a guide, this should allow increase wind and or water spiral affect efficiency within the blades.

2. The Spiral Design can also be used to replace traditional propellors, efficiently utilizing the motion for thrust. By having a thrust that spirals out into a spiraling cone, instead of a traditional tubular shape thrust.
